(19) United States
(12) Patent Application Publication
(10) Pub. No.: US 2008/0117173 A1
(43) Pub. Date: May 22, 2008

(54) KEYBOARD AND HANDHELD INPUT DEVICE SYSTEM

(75) Inventors: Benjamin Roberts, White Rock (CA); John Cavacuiti, North Vancouver (CA); Juan Ernesto Rodriguez, Woodside, CA (US); Steven A. Gelphman, Half Moon Bay, CA (US); Gary Ga Hoi Wong, Vancouver (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA LLC, Lincolnshire, IL (US)

(21) Appl. No.: 11/939,655

(22) Filed: Nov. 14, 2007

Related U.S. Application Data
(60) Provisional application No. 60/866,005, filed on Nov. 15, 2006.

(51) Int. Cl. G06F 3/02

(52) U.S. Cl. 345/169; 345/168

(57) ABSTRACT

A system of computer input devices, such as a keyboard and a mouse, is disclosed. The input device comprises a plurality of keys, a housing coupled to the keys, and a dock formed in the housing. The dock is configured to receive a second input device; and contains a mechanical coupling mechanism for temporarily coupling the second input device to the first input device via the dock.

### CROSS-REFERENCES TO RELATED APPLICATIONS

This patent application is a non-provisional of and claims priority to U.S. provisional patent application No. 60/866,005, filed on Nov. 15, 2006, which is herein incorporated by reference in its entirety for all purposes.

### BACKGROUND OF THE INVENTION

A number of computer input devices, such as computer mice and keyboards, exist today. The keyboard is one of the most frequently used input devices for a personal computer. A typical keyboard has a QWERTY key layout, a numerical keypad, many other kinds of functional keys, indicator lights, and perhaps other features.

Computer mice are often used in conjunction with a keyboard for controlling a computer. Computer mice require a certain amount of flat space in order to suitably perform their control functions. This flat space most often takes the form of desk space located next to the keyboard. Such desk space must remain clear for proper functioning of the mouse.

The combination of a keyboard and a mouse unfortunately takes up a large amount of desktop real estate. Desktop space can be limited in many circumstances. A typical office desk contains, besides the computer and associated peripherals, many papers, books, electronics such as calculators, office supplies, and other assorted work related items. Furthermore, desks often contain personal items too, such as picture frames.

The overabundance of items residing on a typical office desk has created the need for methods of reducing clutter and space. None of these methods are fully satisfactory however, and desk space remains a limited and important resource.

Embodiments of the invention address the above-described issues and other problems.

### BRIEF SUMMARY

Embodiments of the present invention relate to systems for inputting commands to a computer and storing handheld input devices when not in use. One handheld input device is stored within a dock of another, to save on space.

One embodiment of the present invention is directed to a keyboard comprising keys and a housing. Within the housing is a dock for receiving a handheld input device such as a computer input apparatus, such as a computer mouse. The handheld input device temporarily couples to the keyboard by way of a coupling mechanism.

Another embodiment of the present invention is directed to a system comprising a keyboard that includes keys and a housing, and a computer mouse or other type of handheld input device. The computer mouse is coupled to a dock formed in the housing of the keyboard. The system can reside in a horizontal position on a flat surface, or alternatively it can be placed in a vertical position, such that the bottom surface of the keyboard is visible.

Another embodiment of the present invention is directed to a method of storing a computer mouse or other type of handheld input device. In the method, the mouse is placed within a dock formed within a housing of a computer keyboard. The mouse automatically turns off when placed in the keyboard dock, and is stored there while not in use.

Another embodiment of the present invention is directed to a computer handheld input device (or other type of handheld input device) that can be stored in a dock in a keyboard. The handheld input device comprises a housing, a sensor assembly, a host interface connected to the sensor assembly, and a power switch. The switch is set so that when the handheld input device is placed within a dock in a keyboard, the handheld input device powers off.

Another embodiment of the invention is directed to a keyboard comprising a plurality of keys, a housing comprising a bottom portion coupled to the keys, and a visual element such as a picture on the bottom portion of the housing.

These and other embodiments of the invention are described in further detail below.

### BRIEF DESCRIPTION OF THE DRAWINGS

FIG. 1 shows a perspective view of the top of a keyboard according to an embodiment of the invention.

FIG. 2 shows an expanded view of the keyboard of FIG. 1.

FIG. 3 shows a computer handheld input device about to be inserted into a keyboard according to an embodiment of the invention.

FIG. 4 shows a section of a keyboard according to an embodiment of the invention.

FIGS. 5(a)-(c) show a dock according to an embodiment of the invention.

FIG. 6 shows a computer handheld input device according to an embodiment of the invention.

FIG. 7 shows the underside of a keyboard according to an embodiment of the invention.

FIG. 8 shows a system according to an embodiment of the invention.

FIG. 9 shows a circuit diagram of some functional components of a keyboard according to an embodiment of the invention.

FIG. 10 shows a block diagram of some functional components of a keyboard according to an embodiment of the invention.

FIG. 11 shows a block diagram of some functional components of a handheld input system according to an embodiment of the invention.

### DETAILED DESCRIPTION

One embodiment of the present invention is drawn towards a keyboard and a computer handheld input device such as a mouse. The handheld input device can be used with a host device such as a personal computer, television, etc. The handheld input device can be a mouse, which is preferably a wireless mouse, and the keyboard is preferably a wireless keyboard. The mouse may be powered by batteries, and such batteries may be rechargeable or disposable. When the handheld input device is not being used, it can be placed within a dock located on the keyboard. In one implementation, the handheld input device automatically shuts off when it is docked with or temporarily coupled to the keyboard. When the handheld input device is temporarily coupled to the keyboard, there can be some interaction between the keyboard and the handheld input device. For example, in certain implementations, the keyboard automatically shuts off when the handheld input device is docked to the dock in the keyboard. Further, when the handheld input device and the keyboard are temporarily coupled together, the handheld input device may not be easily separated from each other without some additional user response. For example, in some embodiments, to uncouple the keyboard and the handheld input device which may be temporarily coupled together, a user may press a button on the keyboard or the handheld input device to release a latch located in the dock or the handheld input device, thereby allowing the handheld input device to be separated from the keyboard.

A “dock” can have any suitable configuration. In some embodiments the dock can be in the form of, or have, a recess, hole, or protrusion. The dock can generally be a designated location for storing the handheld input device when the handheld input device is not being used to input data into a host device.

In the specific embodiments that are described below, a “handheld input device” is described in detail and a host in the form of a computer is described in detail. Embodiments of the invention are not limited to the specific embodiments described herein, and embodiments of the invention may be used to control devices including computers, MP3 players, televisions, projectors, etc. Also, the “handheld input device” is preferably a computer handheld input device such as a computer mouse or keyboard.

A “handheld input device” may also have any suitable configuration, and is used to input data into a host device. In preferred embodiments, the host device is a computer, and the handheld input device is a computer mouse. The specific examples mention mice, keyboards, and computers for ease of illustration, but embodiments of the invention are not limited to such embodiments.

In embodiments of the invention, a mouse docks onto the keyboard preferably by using a mechanical coupling mechanism. The mechanical coupling mechanism can both temporarily couple to and hold onto the mouse, and actuate a power button on it so that the mouse shuts down after it temporarily couples to the keyboard. Further, in a preferred embodiment, the keyboard is structured so that it may be set in a vertical position when it is not in use. The mouse that is docked within the dock in the keyboard can support the keyboard standing upright, functioning much as a leg of a tripod does. With the keyboard in an upright, or vertical, position, its underside or bottom surface will be visible. Any number of functional attachments may be included on the underside, such as a picture frame.

Embodiments of the invention have a number of advantages. When the mouse and keyboard set is not being used, occupied desk space is minimized. Battery life is extended since one or both of the input devices is automatically shut off. This reduces power consumption as fewer batteries are required over time, thus resulting in costs savings and environmental benefits. Further, the undersides of keyboards have previously been unused. In embodiments of the invention, the keyboard can stand upright, and the underside of the keyboard can include a visual element such as a picture holder. By being able to stand upright, the keyboard can be utilized in a non-obvious and useful way.

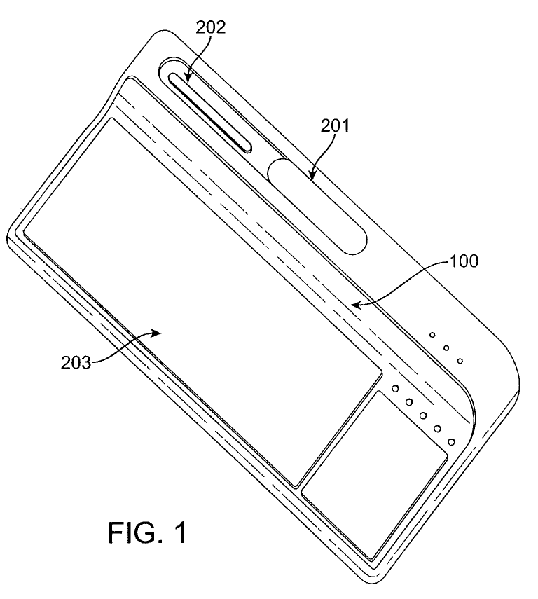

FIGS. 1 through 4 show various views and embodiments of a keyboard and a handheld input device according to an embodiment of the invention.

FIG. 1 shows the top of a keyboard 100 according to an embodiment of the invention.

The keyboard 100 contains a section of keys 203 and a row of buttons 202 along the top. There is a door 201 that covers a dock that couples to a mouse. In this embodiment, door 201 operates by sliding across to cover buttons 102 when not covering the dock. Alternatively, door 201 may be moveable by means of a hinge or other suitable means, or may be fully removable from the keyboard 100.

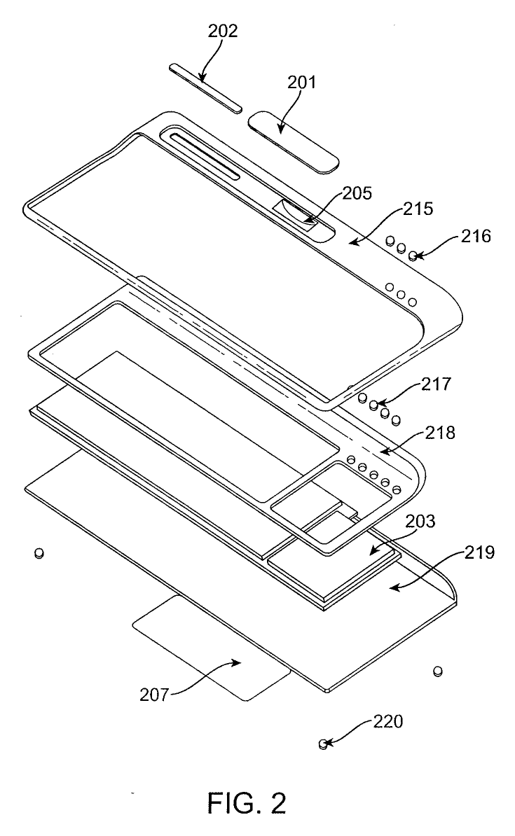

FIG. 2 shows an exploded view of the keyboard of FIG. 1. Buttons 202 and door 201 are shown above a top housing portion 215 of the keyboard. A dock 205 can be at least partially formed in the top housing portion 215, and may be selectively covered by door 201. In this embodiment, dock 205 comprises a recess formed within top housing 215. Lightpipes 216 connect to lights (not shown), and allow for radiated light to be viewable by the user when the keyboard is in use. A central housing portion 218 holds the keys 203 and 217 in place. Bottom housing portion 219 contains a holder 207. At least part of the bottom housing portion 219, the central housing portion 218, and the top housing portion 215 can form a housing for the keyboard.

The holder 207 can contain a calendar, a picture frame, a calculator, a clock, or other suitable visual element that is usable when the keyboard is resting in a vertical or substantially vertical position, as described below. When the keyboard is placed in a horizontal position, for use during data entry or control of a computer for example, feet 220 support the keyboard.

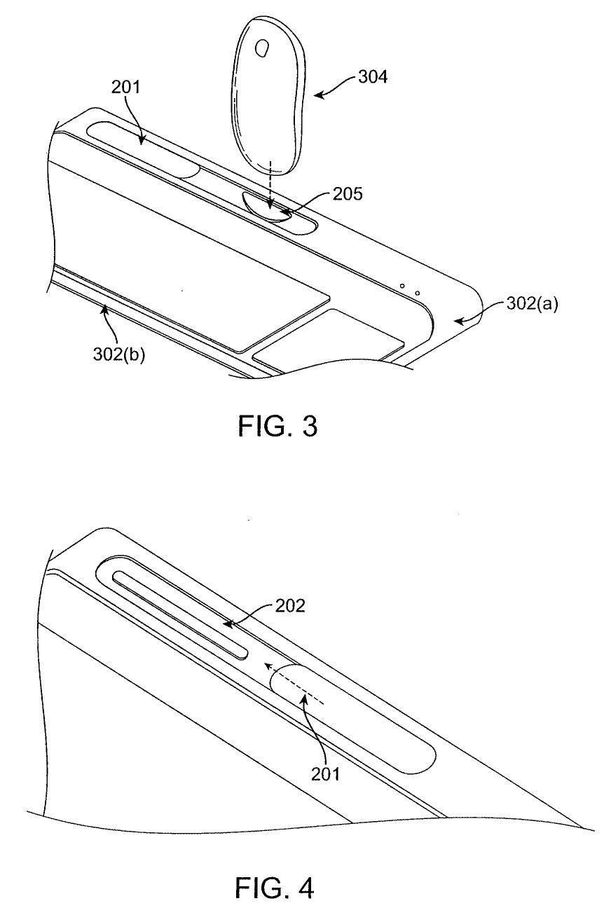

FIGS. 3 and 4 show a close up of a portion of a keyboard according to an embodiment of the invention. FIG. 3 shows door 201 in the open position, for when a mouse 304 is to be docked with a keyboard. Mouse 304 is configured to couple to the keyboard via the dock 205, and comprises a sensor assembly for sensing the mouse position relative to a work surface and a host interface connected to the sensor assembly for communicating with a host device.

In this embodiment, door 201 is a sliding door that is covering buttons (not shown) that are attached to the keyboard. In alternative embodiments, the keyboard does not have buttons under door 201 in the open position. With the door 201 in the open position, dock 205 is exposed and ready to dock with mouse 304. In this embodiment, dock 205 takes the form of a recess. In other embodiments, dock 205 may include a magnet, a clasp, or other suitable mechanism for coupling with mouse 304. FIG. 4 shows door 201 in the closed position, such that it is covering dock 205. In this state, a mouse (not shown) is not docked with the keyboard, and is available to input commands to a host device. Buttons 202 are visible, and are available to input commands to a host device.

Referring to FIG. 3, to allow the keyboard to be in a vertical position, the housing may include a first portion 302(a) that is wider than a second portion 302(b). In this example, the first portion 302(a) is a rear portion and the second portion 302(b) is a front portion. In some embodiments, the first portion 302(a) may be about twice the thickness of the second portion 302(b).

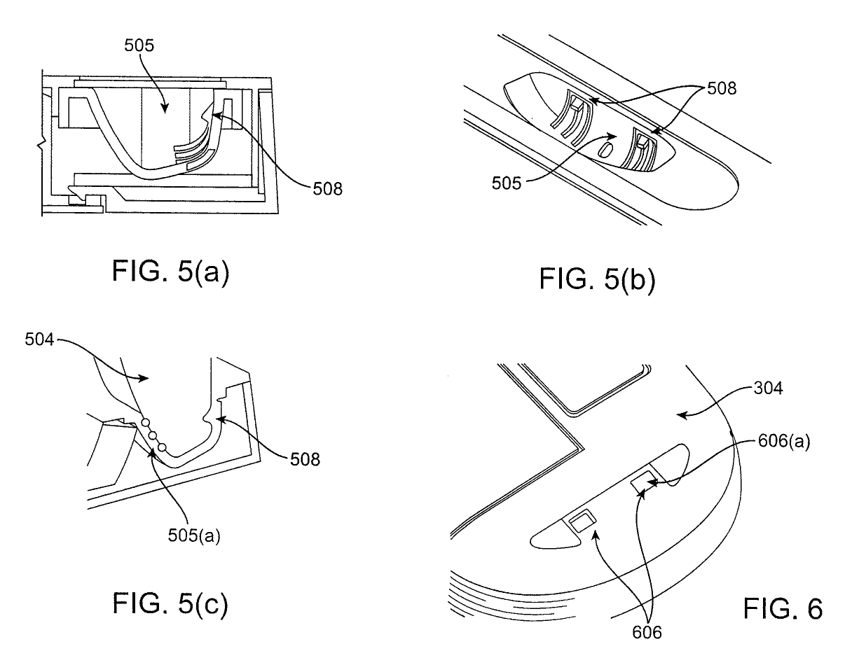

FIGS. 5(a) through (c) show several views of a dock according to an embodiment of the invention. In this embodiment, the dock is defined by a recess 505. FIG. 5(a) shows a cut-away side view of recess 505. Mechanical coupling mechanism 508 is shown on a side of the recess 505. Mechanical coupling mechanism is preferably in the form of one or more hooks, but may also be in the form of a clasp, leaf springs, ball bearing detent mechanisms, or other engagement structures. FIG. 5(c) shows a mouse 304 coupled to the dock 505 by mechanical coupling mechanism 508. On the opposite side of recess 505 from the mechanical coupling mechanism 508 are one or more soft pads 505(a) to cushion mouse 504 while it is docked. The pads 505(a) help to grip the mouse 504 and prevent any scratching or other damage during coupling.

The use of a mechanical coupling system has advantages. Using a mechanical coupling system ensures a strong couple between the handheld input devices that will not fade over time. No electrical power is required, saving energy costs and ensuring that the coupling does not fail upon any loss of power. Other methods of coupling, such as magnetic systems, may not provide as secure a connection. Further, using a mechanical coupling system is more cost effective and less error prone than alternative systems.

FIG. 6 shows a portion of an underside of a mouse 304 according to an embodiment of the invention. Mouse 304 has one or more cavities 606 for coupling to the mechanical coupling system 508. In a preferred embodiment, the cavities 606 latch onto one or more hooks 508 as seen in FIG. 5(b). Mouse 304 also contains a switch 606(a) that is activated when the mouse 304 is placed in the recess 505. The switch 606(a) may automatically turn the mouse 304 off so that the power in the mouse 304 is not drained. Switch 606(a) may reside within one or more of the grooves 606 as shown in FIG. 6, or alternatively it may reside in another part of mouse 304. Switch 606(a) is preferably a mechanical switch, but it may alternatively be an electrical switch. In certain preferred embodiments, the keyboard 100 that docks with mouse 304 is a wireless keyboard, and may also have a switch (not shown) that will automatically power down the keyboard upon docking with mouse 304.

Advantageously, as shown above, embodiments of the invention can store a handheld input device in a neat manner while conserving power in the keyboard and/or the handheld input device.

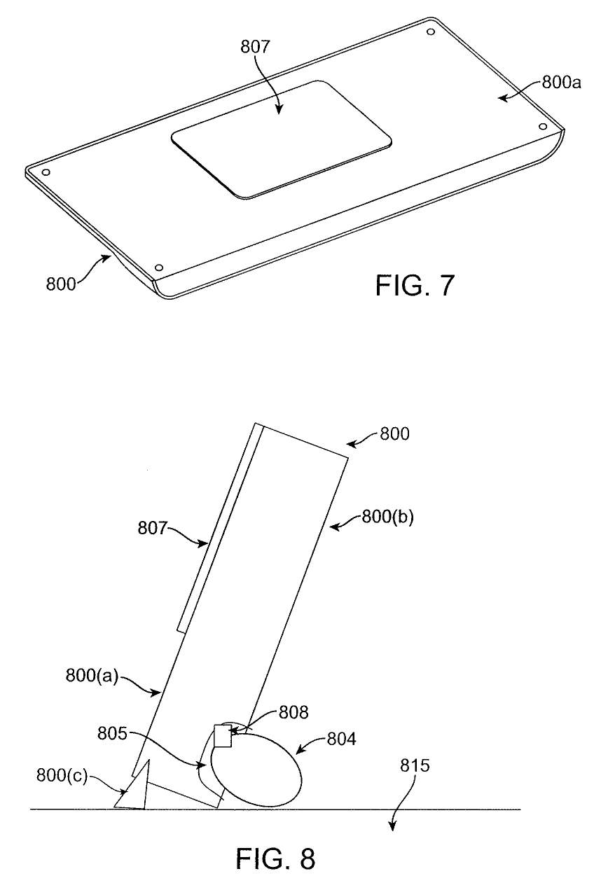

An embodiment of the invention provides for the use of an underside of the keyboard. When the keyboard is not being used for inputting commands to a host system, it may be configured such that a previously inaccessible area of the device becomes usable. FIG. 7 shows a bottom view of a keyboard according to this embodiment. Keyboard 800 has a bottom portion including a bottom surface 800(a) that is in contact with a work surface (not shown) when keyboard 800 is inputting data to a host device. In this example, bottom surface 800(a) comprises holder 807. Holder 807 may comprise a picture holder, a calendar, a clock, a calculator, or other usable object. Such object will reside out of the way, on bottom surface 800(a) during data entry with a host device, but is accessible once keyboard 800 is flipped so that bottom surface 800(a) is visible.

FIG. 8 depicts the keyboard of FIG. 7 in a position to use the object 807 located on the bottom surface 800(a) of the keyboard. Keyboard 800 has been placed in a substantially vertically oriented position, such that bottom surface 800(a) is visible. In data entry mode, bottom surface 800(a) is normally in contact with work surface 815, and top portion 800(b) is visible. When not in data entry mode, a computer handheld input device such as a mouse 804 can be stored in dock 805. Dock 805 comprises coupling device 808, which couples to mouse 804. In preferred embodiments, as shown in FIG. 8, mouse 804 functions as a support member of keyboard 800 while in a substantially vertically oriented position. Mouse 804 acts much as one leg of a tripod does, in this implementation. Alternatively, keyboard 800 can stand in a substantially vertically oriented position without mouse 804 docked within. In this implementation, keyboard 800 can stand vertically oriented, supported by itself. In certain implementations, keyboard 800 comprises one or more feet 800(c), which aid in stabilizing keyboard 800 while in a substantially vertical position. Feet 800(c) may extend or fold out of keyboard 800 when used, and store back within the keyboard 800 when not in use. Alternatively, feet 800(c) may be detachable and connect onto keyboard 800 for use in stabilization.

Bottom surface 800(a) comprises holder 807. Holder 807 is a functional element that may be accessed when the keyboard 800 is in a substantially vertical position. Holder 807 may preferably be any of a picture holder, a calendar, a clock, a calculator, or any suitable element. While keyboard 800 is in a substantially vertical position, as shown in FIG. 8, holder 807 is accessible by a user. This adds functionality while also minimizing the space taken up by the handheld input devices of the invention.

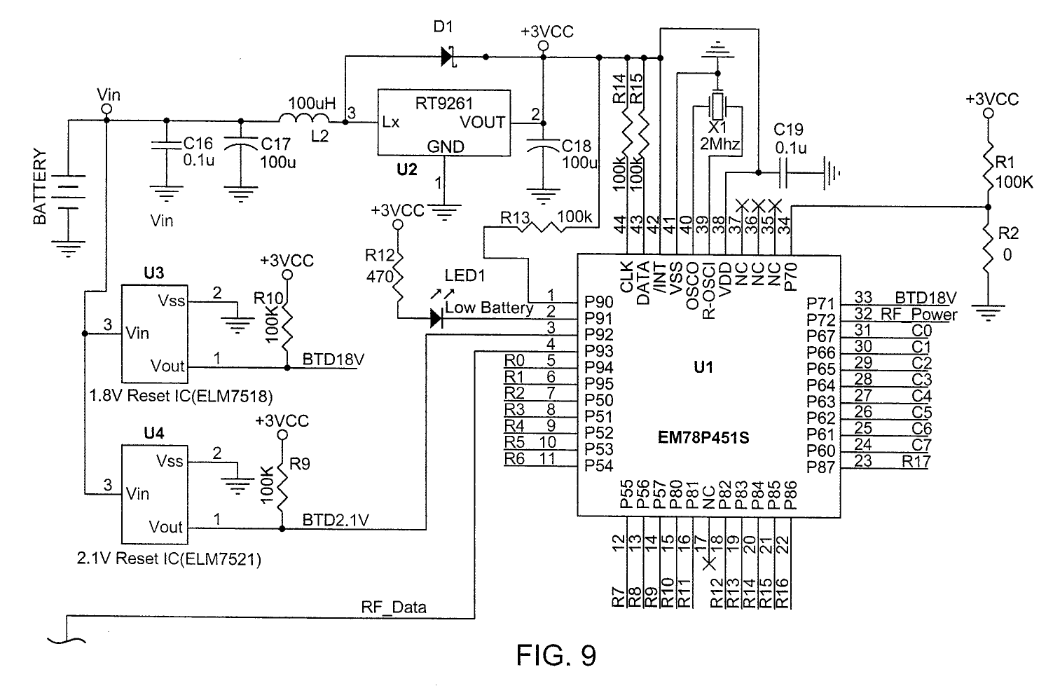

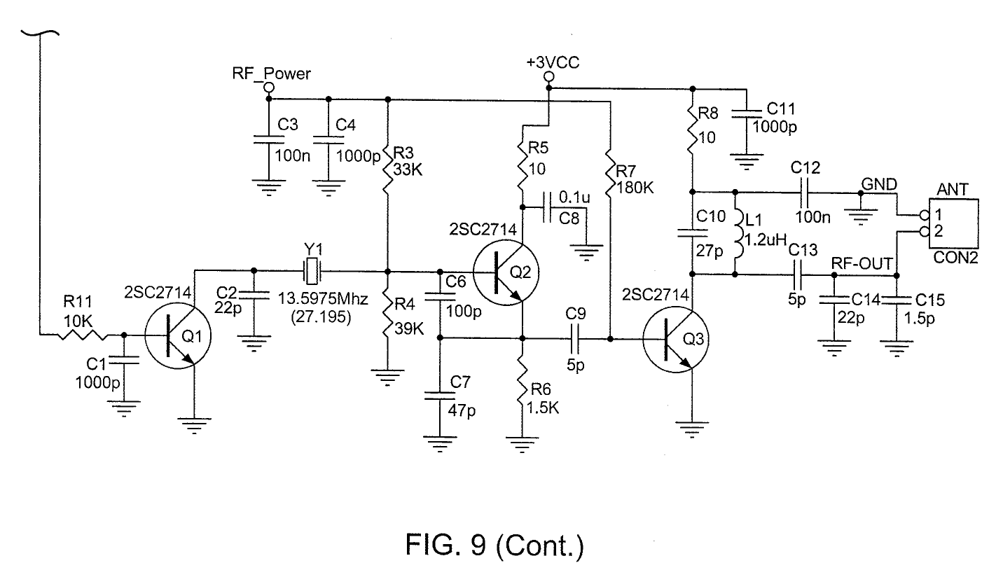

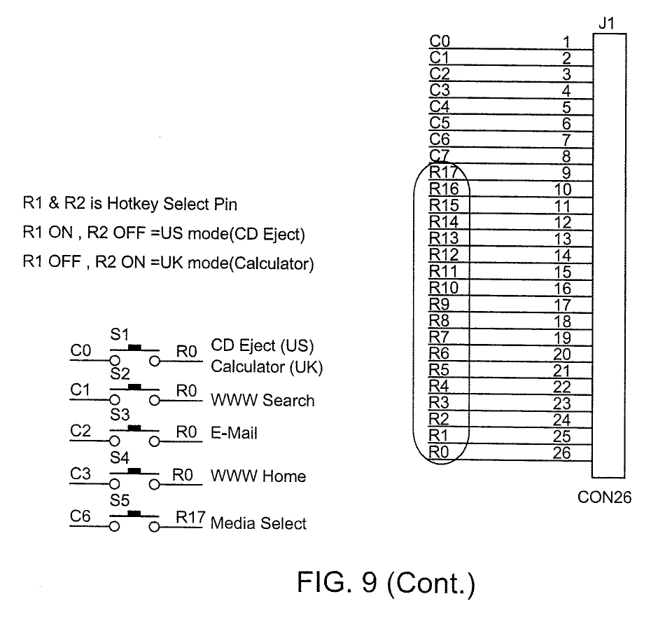

An exemplary circuit diagram of an embodiment of the invention is shown in FIG. 9. It is understood that other suitable circuits could alternatively be used in embodiments of the invention, and embodiments of the invention are not limited to the specific implementation shown in FIG. 9.

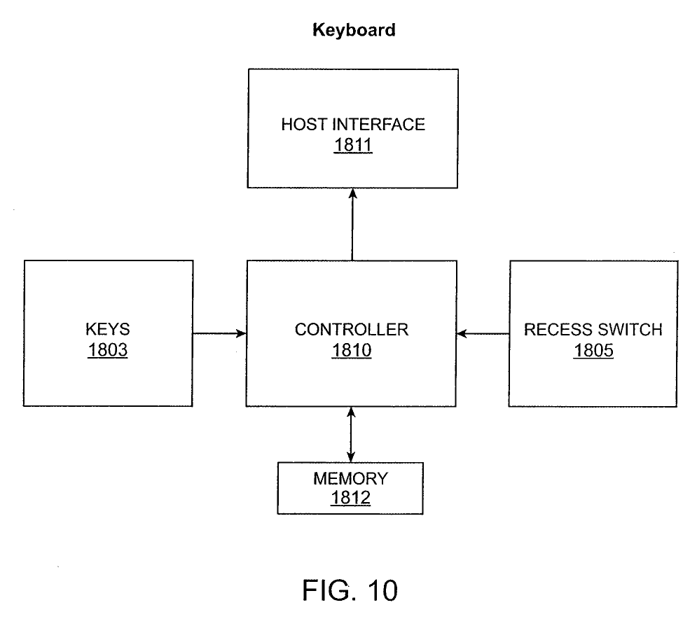

FIG. 10 shows a block diagram of a system, such as a keyboard, according to an embodiment of the invention. The system may include an input device with keys 1803. Keys 1803 may be operatively coupled to a controller 1810, and control signals may be sent from keys 1803 to the controller 1810. When keys 1803 are depressed on the system, that signal is routed through the controller to host interface 1811. The controller 1810 can be a microprocessor and may be separately packaged from the host interface 1811 or within the same package as host interface 1811. Host interface 1811 communicates with a host system (not shown), and sends it the commands from the keys. Recess switch 1805 is also coupled to and instructs the controller 1810 as to when the system will power off and when it will power on. The recess switch 1805 is an automatic power switch that that can automatically turn off the system upon the occurrence of another handheld input device (not shown) docking with the system. Memory 1812 may be coupled to the controller and may include a computer readable medium comprising code for causing the keyboard to automatically power down when the recess switch 1805 is activated. The memory 1812 may also comprise code for performing any of the functions that may be performed by the keyboard.

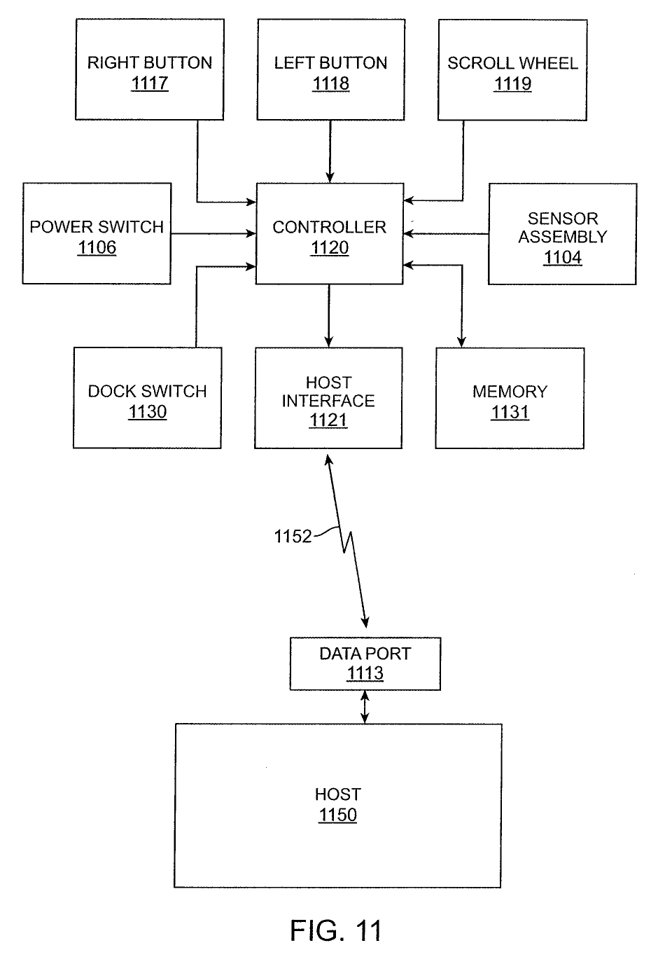

FIG. 11 shows a block diagram of an input device according to an embodiment of the invention. The input device is configured to dock with an input device such as a keyboard. The input device may comprise left button 1117 and a right button 1118 for control by a user, along with a scroll wheel 1119. Each of the left button 1117, the right button 1118, and the scroll wheel 1119 may be operatively coupled to a controller 1120, and control signals may be sent from them to the controller 1120. The controller 1120 can be a microprocessor and may be separately packaged from the sensor assembly 1104 or within the same package as the sensor assembly 1104.

A sensor assembly 1104 is also coupled to the controller 1120. The sensor assembly 1104 is preferably an optical sensor assembly, but it may also be a mechanical or other type of sensor assembly. Sensor assembly 1104 senses the position of the input device relative to a work surface, and sends that information in the form of a signal to controller 1120. In preferred embodiments, the sensor assembly 1104 contains a light source such as an LED or laser. The light source provides light to a work surface and reflected light from the work surface can be received by a camera or the like in the sensor assembly 1104.

A power switch 1106 is also coupled to and instructs the input device controller 1120 as to when the computer input device will power off and when it will power on. The power switch 1106 can be a manual power switch that can be actuated by a user, or can be an automatic power switch that can automatically turn off the computer input device by working in conjunction with controller 1120 and memory 1131 (e.g., when the computer input device has not been used for a predetermined time). Further, separate dock switch 1130 also is coupled to and instructs the input device controller 1120 as to when the input device will power off and when it will power on. Dock switch is activated when the input device docks with a keyboard as shown in FIG. 5(c), such that the input device powers down upon docking. Memory 1131 may be coupled to the controller and may include a computer readable medium comprising code for causing the input device to automatically power down when the dock switch 1130 is activated. The memory 1131 may also comprise code for performing any of the functions that may be performed by the keyboard.

As shown in FIG. 11, controller 1120 coordinates the various signals it receives and delivers them to a host 1150 through host interface 1121. Host 1150 is preferably a personal computer, but may be any electronic device capable of accepting control signals. Host 1150 receives control signals through a data port 1113. Data port 1113 may be any port that will accept control signals, such as a PCI Express-type port, a USB port, a wireless receiver, or the like.

In different embodiments, controller 1120 may communicate with the host in either a wired or a wireless fashion through connection 1152. In one embodiment, connection 1152 is a cable that transmits the communication (e.g., data) signals between host interface 1121 and data port 1113. Data port 1113 receives the data signals from host interface 1121, and sends the desired signal to the host 1150.

In another embodiment, communication occurs in a wireless fashion. In this embodiment, the controller 1120 routes the communication signal through host interface 1121. Host interface 1121 emits wireless signals 1152 that are received by data port 1113. Wireless signals 1152 can conform to any number of wireless standards, including 27 MHz, 2.4 GHz, Bluetooth, or any other suitable standard. In a preferred embodiment, the 27 MHz standard is used. Data port 1113 receives the wireless signals from host interface 1121, and sends the desired signal to the host 1150.

Methods for using the computer input devices of the invention are also disclosed. In one embodiment, a method of use includes placing a mouse in a dock formed within a housing of a computer keyboard, in order to have the mouse dock with the keyboard. The mouse automatically powers off upon docking with the keyboard. Then, the keyboard with mouse inside can be placed in a substantially vertical position so that the mouse acts as a support structure. This reveals the underside of the computer, which can comprise a picture holder, a calendar, a clock, a calculator, or other like device. Any of the above descriptions of specific components may be used in such methods of use.

Embodiments of the invention may also include various systems that can incorporate any suitable combination of the above-described components. For example, some systems may include two input devices, an input device in combination with a host, etc.

Embodiments of the invention have a number of advantages. For example, as noted above, embodiments of the invention provide for storage of a computer input device when not in use, and further ensure that input devices are powered off in such state. Thus, a user can free extra desk space for use in non-computer related activities, and also will save on energy costs.

It is noted that the present invention is not limited to the preferred embodiments described above, and it is apparent that variations and modifications by those skilled in the art can be performed within the spirit and scope of the present invention. Moreover, any one or more embodiment of the invention may be combined with one or more embodiments of the invention without departing from the spirit and scope of the invention.

Any recitation of “a”, “an” and “the” is interpreted to mean “one or more” unless specifically indicated to the contrary.

What is claimed is:

1. A keyboard comprising:
a plurality of keys;
a housing coupled to the keys;
a dock formed in the housing, wherein the dock is configured to receive an input device; and
a mechanical coupling mechanism for temporarily coupling the input device to the keyboard via the dock.

2. The keyboard of claim 1 wherein the dock comprises a recess.

3. The keyboard of claim 2 wherein the mechanical coupling mechanism comprises one or more hooks within the dock, wherein the one or more hooks are configured to latch onto one or more structures within cavities formed in the input device.

4. The keyboard of claim 2 wherein the keyboard is adapted to automatically power down when the input device temporarily couples to the keyboard.

5. The keyboard of claim 2 wherein the input device is adapted to automatically power down when the input device is coupled to the keyboard.

6. The keyboard of claim 1 wherein the keyboard and input device are adapted to automatically power down when the input device is coupled to the keyboard.

7. The keyboard of claim 1 wherein the keyboard is configured to be able to stand in a substantially vertically oriented position.

8. The keyboard of claim 7 further comprising a picture holder, a calendar, a clock, or a calculator on a bottom surface of the housing.

9. The keyboard of claim 1 further comprising a door built into the housing, wherein the door is configured to cover the dock when not in use.

10. A system comprising:
a keyboard comprising a plurality of keys, a housing coupled to the keys, and a dock formed in the housing; and
a computer mouse temporarily coupled to the dock.

11. The system of claim 10 wherein the computer mouse is oriented substantially perpendicular to an orientation of the keyboard when the computer mouse is temporarily coupled to the dock.

12. The system of claim 11 wherein the mouse supports the keyboard in the substantially vertically oriented position on the flat surface.

13. The system of claim 11 wherein a bottom surface of the housing comprises a picture holder, a calendar, a clock or a calculator.

14. The system of claim 10, wherein both of the mouse and the keyboard are configured to be automatically turned off when the mouse is in the dock.

15. The system of claim 10 wherein the mouse is a wireless mouse.

16. The system of claim 15, wherein the mouse is configured to be automatically turned off when the mouse is in the dock.

17. The system of claim 10 wherein the keyboard is a wireless keyboard.

18. The system of claim 10 further comprising a door built into the housing;
wherein the door is configured to cover the dock when the mouse is not inserted; and
wherein the door covers a plurality of computer keys when not covering the dock.

19. The system of claim 10 wherein the mechanical coupling comprises engagement structures within the dock connecting to corresponding portions of the mouse.

20. The system of claim 19 wherein an end of the mouse is coupled to the dock such that the mouse is oriented in a perpendicular position with the keyboard.

21. A method of storing a computer mouse, comprising:
placing the mouse in a dock formed within a housing of a computer keyboard such that the mouse is docked within the keyboard;
wherein the mouse automatically turns off upon being placed in the dock.

22. The method of claim 21 further comprising:
placing the keyboard with docked mouse on a flat surface, such that the bottom surface of the keyboard is visible.

23. The method of claim 22 wherein the bottom surface of the keyboard comprises a picture holder, a calendar, a clock or a calculator.

24. The method of claim 22 wherein the mouse supports the keyboard in the substantially vertically oriented position on the flat surface.

25. A handheld input device comprising:
a housing;
a sensor assembly configured to sense the position of the input device relative to a work surface;
a host interface connected to the sensor assembly;
a power switch, wherein the power switch is configured to be set to a power off mode when the input device is placed within a dock of a keyboard, wherein the dock is configured to receive the computer input device.

26. A keyboard comprising:
a plurality of keys;
a housing comprising a bottom portion coupled to the keys; and
a visual element on the bottom portion of the housing.

27. The keyboard of claim 26, wherein the visual element is a picture holder, a calendar, a clock, or a calculator.
